(19) United States
(12) Patent Application Publication
(10) Pub. No.: US 2006/0025180 A1
(43) Pub. Date: Feb. 2, 2006

(54) Method for waking a wireless device

(75) Inventors: Amol Rajkotia, San Diego, CA (US); Ranganathan Krishnan, San Diego, CA (US)

Correspondence Address: QUALCOMM, INC, 5775 MOREHOUSE DR., SAN DIEGO, CA, 92121, US

(73) Assignee: QUALCOMM Incorporated

(21) Appl. No.: 10/903,093

(22) Filed: Jul. 30, 2004

(51) Int. Cl. H04B 1/38

(52) U.S. Cl. 455/574

(57) ABSTRACT

A method of reducing power consumption by waking a wireless device based on hashing a unique identifier of the wireless device is disclosed. A hash function is applied to a unique identifier; a wakeup time is determined based on the hashed unique identifier; and the wireless device is awoken at the wakeup time.

### FIELD

The present invention relates generally to wireless communication devices and systems and more specifically to waking wireless devices.

### BACKGROUND

The field of communications has many applications including, e.g., paging, wireless local loops, Internet telephony, and satellite communication systems. An exemplary application is a cellular telephone system for mobile subscribers. (As used herein, the term “cellular” system encompasses both cellular and personal communications services (PCS) system frequencies.) Modern communication systems designed to allow multiple users to access a common communications medium have been developed for such cellular systems. These modern communication systems may be based on code division multiple access (CDMA), Time Division Synchronous Code Division Multiple Access (TD-SCDMA), time division multiple access (TDMA), frequency division multiple access (FDMA), space division multiple access (SDMA), polarization division multiple access (PDMA), or other modulation techniques known in the art. These modulation techniques demodulate signals received from multiple users of a communication system, thereby enabling an increase in the capacity of the communication system. In connection therewith, various wireless systems have been established including, e.g., Advanced Mobile Phone Service (AMPS), Global System for Mobile communication (GSM), and some other wireless systems. Other wireless systems include Ultra-Wideband (UWB) systems.

In conventional wireless communications, an access network is generally employed to support communications for a number of devices. An access network is typically implemented with multiple fixed site base stations dispersed throughout a geographic region. The geographic region is generally subdivided into smaller regions known as cells. Each base station may be configured to serve the devices in its respective cell. An access network may not be easily reconfigured when there are varying traffic demands across different cellular regions.

In contrast to the conventional access network, ad-hoc networks are dynamic. An ad-hoc network may be formed when a number of wireless communication devices, often referred to as terminals, join together to form a network. Terminals in ad-hoc networks can operate as either a host or router. Thus, an ad-hoc network may be easily reconfigured to meet existing traffic demands in a more efficient fashion. Moreover, ad-hoc networks do not require the infrastructure required by conventional access networks, making ad-hoc networks an attractive choice for the future.

Ultra-Wideband (UWB) is an example of a communications technology that may be implemented with ad-hoc networks. UWB provides high speed communications over a wide frequency bandwidth. At the same time, UWB signals are transmitted in very short pulses that consume very little power. The output power of the UWB signal is so low that it looks like noise to other RF technologies, making it less interfering.

A number of different devices can be UWB-enabled, for example, mobile phones, personal digital assistants or laptop computers. Each such device is equipped with UWB components, including a receiver and transmitter, allowing it to communicate with other similarly equipped devices nearby without the use of cables or other physical connections.

As an example, a wireless code division multiple access (CDMA) mobile phone can be UWB-enabled, meaning that the mobile phone would be able to communicate with both a CDMA network and a UWB network. Such a UWB-enabled CDMA mobile phone may comprise both UWB and CDMA components.

A UWB-enabled device may be configured to communicate with wireless networks other than CDMA. Thus, a UWB-enabled device may be configured to communicate with GSM, GPRS, W-CDMA, or any other network known in the art.

A UWB-enabled device may be configured to communicate with a plurality of different types of networks. Thus, a UWB-enabled device may be configured to communicate with CDMA and GSM networks in addition to UWB networks.

Wasteful or excessive power consumption is a concern in wireless devices since it can hinder the device's operation and detract from its usefulness. Wasteful or excessive power consumption is a particular concern in multi-mode devices because power can be consumed by a plurality of components that are needed to communicate with a plurality of networks.

There is therefore a need in the art for a method and related system to reduce the amount of power consumed by a wireless device.

### SUMMARY

Embodiments disclosed herein address the above stated needs by reducing the amount of power consumed by a wireless device.

In an aspect, a method for waking a wireless device comprises applying a hash function to a unique identifier, determining a wakeup time based on the hashed unique identifier, and waking the wireless device at the wakeup time.

In an aspect, the hash function produces an integer i (1≦i≦k; 1<k≦n, where k is a system parameter and n is the number of terminals in a network).

In an aspect, a wireless terminal comprises means for applying a hash function to a unique identifier, means for determining a wakeup time based on the hashed unique identifier, and means for waking the wireless device at the wakeup time.

In an aspect, computer readable media embodying a program of instructions executable by a computer program comprises a computer readable program code means for applying a hash function to a unique identifier, a computer readable program code means for determining a wakeup time based on the hashed unique identifier; and a computer readable program code means for waking the wireless device at the wakeup time.

### BRIEF DESCRIPTION OF THE DRAWINGS

FIG. 1 is a block diagram of an exemplary wireless communication system in accordance with an embodiment of the invention.

FIGS. 2A, 2B and 2C show graphs illustrating wakeup schedules for three different hash values in accordance with an embodiment of the invention.

FIG. 3. shows flowchart describing an exemplary process for waking up a wireless device based on a hash of unique identifier of the wireless device.

### DETAILED DESCRIPTION

The present invention is directed to reducing power consumption in a wireless device. Although the invention is described with respect to specific embodiments, the principles of the invention, as defined by the claims appended herein, can obviously be applied beyond the embodiments of the description described specifically herein. Moreover, certain details have been left out in order to not obscure the inventive aspects of the invention. The specific details not described in the present application are within the knowledge of a person of ordinary skill in the art.

The drawings in the present application and their accompanying detailed description are directed to merely example embodiments of the invention. To maintain brevity, other embodiments of the invention that use the principles of the present invention are not specifically described in the present application and are not specifically illustrated by the present drawings. The word “exemplary” is used exclusively herein to mean “serving as an example, instance, or illustration.” Any embodiment described herein as “exemplary” is not necessarily to be construed as preferred or advantageous over other embodiments.

In an embodiment, a wireless device assumes a standby mode when the wireless device is not actively communicating with other wireless devices, i.e. it is not participating in a network. While in standby mode, the wireless device searches for other wireless devices by periodically performing a wakeup process during which process it scans the surrounding environment for other wireless devices. If the wireless device encounters other wireless devices during the scanning process and determines that a connection is needed, it can perform certain protocols in order to establish a short-range, wireless connection between the phone and such other devices. Otherwise, the scanning task is turned off until a next wakeup process.

In a CDMA mobile phone (“phone”), for example, the standby cycle of waking-up, scanning and turning off repeats typically once, twice, or four times every 1.28 seconds for the duration of the standby period. However, it is appreciated that certain specifications may vary the timing and pattern of the cycle, for example requiring that the process be performed continuously for 1.28 seconds, or repeating the process sixteen times every 1.28 seconds. Further, certain specifications may require that the wakeup process be repeated, for example, at least once every 1.28 seconds, every 2.56 seconds, or any other interval which a particular specification may require.

Since CDMA requires precise time synchronization between the phone and the base station, one task the CDMA component has to perform is to synchronize with the base station. In order to synchronize with the base station while in idle mode, the CDMA component “wakes up” periodically during its allotted time slots to receive and process pilot signals from the base station on a CDMA Paging Channel. The CDMA component can synchronize with the base station by processing the pilot signals. For instance, the system time can be determined from the information embedded in the pilot signals.

In CDMA, terminals are awoken based on slot cycle index and offset from the slot cycle index. How frequently the CDMA component wakes up is governed by the slot cycle index, which can be set by either the phone or the base station, as is known in the art. If the slot cycle index is zero, the CDMA component performs a wakeup process every 1.28 seconds, i.e. its allotted time slot comes around every 1.28 seconds. Alternatively, the slot cycle index can be set at, for example, one, in which case the wakeup process is performed every 2.56 seconds, or two, in which case the wakeup process is performed every 5.12 seconds. Thus, the lower the slot cycle index, the more frequently the wakeup process is repeated and the greater the power consumed.

In an ad-hoc network, power consumption is reduced by hashing a unique identifier of the receiving terminal in accordance with an embodiment. For example, a transmitting terminal sends a wakeup signal to a receiver based on a hash of the receiving terminal's phone number. In an embodiment, the unique identifier is an International Mobile Subscriber Identity (IMSI). It would be apparent to those skilled in the art that the unique identifier can be a subfield of data or can be the result of combining and/or processing several fields of data.

The unique identifier is an input to the hash function. There are many hash function that are apparent to those skilled in the art that can be used. A hash function can be chosen based on design considerations.

The hash function produces an integer i (1≦i≦k; 1<k≦n, where n is the number of terminals). In accordance with an embodiment, k is static. k is a system parameter programmed into all the terminals. k is determined based on the design considerations of the network. The higher the k, the longer the terminal sleep time, which saves power and the longer the latency between wake up times. Latency is a function of order of magnitude km, where km is a latency period between wake up times. m is a granular period of time; therefore, km is a k-multiple of the granular period of time.

The hash function produces an integer offset i from a system time. The system time can be geographical, Global Positioning System (GPS), or some local time for instance. The system time can even be a cellular based system time such as a CDMA-based system time.

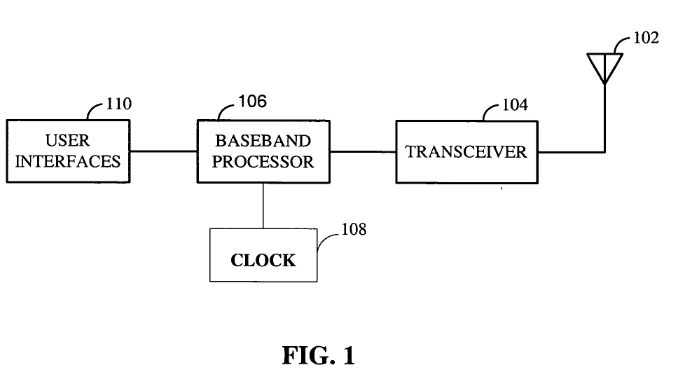

FIG. 1 illustrates an exemplary wireless terminal in accordance with an embodiment of the invention. The terminal may be implemented with a front end transceiver 102 coupled to an antenna 104. A baseband processor 106 may be coupled to the transceiver 102. The baseband processor executes the hash function.

The baseband processor 106 may be implemented with a software based architecture, or other type of architecture. A microprocessor may be used as a platform to run software programs that, among other things, provide control and overall system management functions that allow the terminal to operate either as a master or member terminal. A digital signal processor (DSP) may be implemented with an embedded communications software layer which runs application specific algorithms to reduce the processing demands on the microprocessor. The DSP may be used to provide various signal processing functions such as pilot signal acquisition, time synchronization, frequency tracking, spread-spectrum processing, modulation and demodulation functions, and forward error correction.

The baseband processor 106 is coupled to a clock 108. In an embodiment, the clock is a GPS clock. The terminal may also include various user interfaces 110 coupled to the baseband processor 106. The user interfaces may include a keypad, mouse, touch screen, display, ringer, vibrator, audio speaker, microphone, camera and/or other input/output devices.

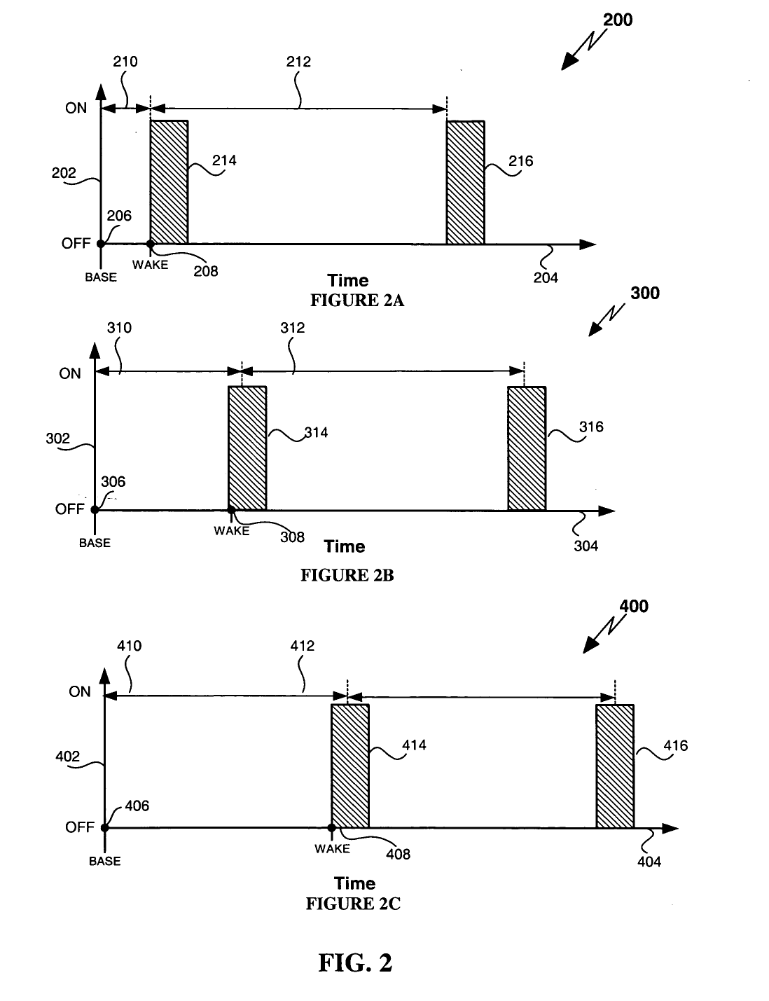

FIGS. 2A, AB and 2C show the wakeup schedules in accordance with an embodiment. Graphs 200, 300 and 400 illustrate wakeup schedules for different hash values i in accordance with an embodiment.

Graph 200 illustrates a time sequence of the wakeup schedule for a wireless terminal. In graph 200, axis 202 shows the on/off state and axis 204 corresponds to time. A base time is shown as BASE 206. The base time 206 is computed based on a system time. For example, the system time can be an epoch time such as Jan. 1, 2000.

The terminal is in idle mode at BASE time 206 and not performing a wakeup process, i.e. the terminal is “off” in that it is in standby mode.

However, at WAKE time 208, the terminal turns on and begins a wakeup process 214. The time interval between BASE time 206 and WAKE time 208 is an offset shown in graph 200 as interval 210. Thus, interval 210 represents the time period between the current time and the time when the next wakeup process is to be performed. Interval 212 represents the time between the start of wakeup process 214 and the start of wakeup process 216. Interval 212 can be, for example, 1.28 seconds, meaning that the terminal is set to perform a wakeup process every 1.28 seconds.

Once the time for the next scheduled wakeup process has been established in the manner described above, the time remaining until that next scheduled wakeup process can be determined by calculating the time difference between the base time and the time of that next scheduled wakeup process. Accordingly, baseband processor 106 can determine the time remaining until the next scheduled wakeup process.

Graph 200 shows an interval 210. The interval 210 is equal to i*m where i=1. Graph 300 shows an interval 310. The interval 310 is equal to i*m where i=2. Interval 310 is twice as long as interval 210. Graph 400 shows an interval 410. The interval 410 is equal to i*m where i=3. Interval 410 is three times as long as interval 210.

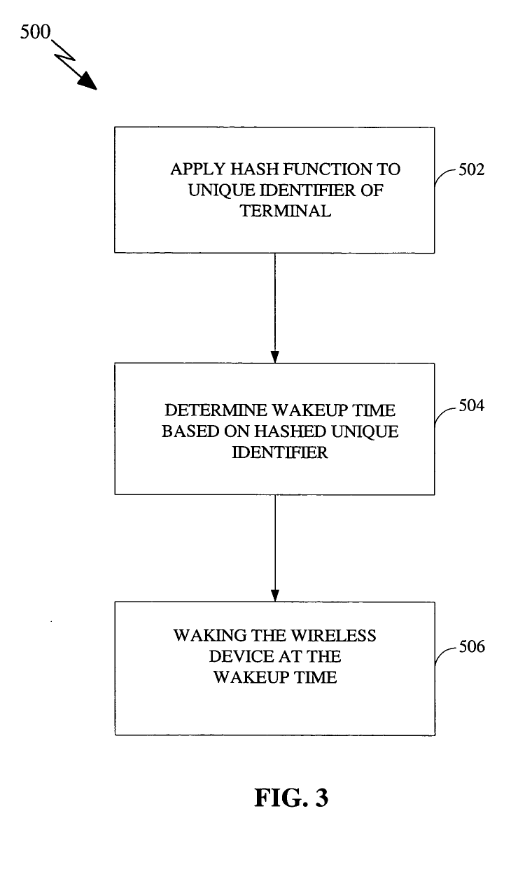

FIG. 3 shows flowchart 500 describing an exemplary process for waking up a wireless device based on a hash of unique identifier of the wireless device. In step 502, a hash function is applied to a unique identifier of a wireless device. In step 504, a wakeup time is determined based on the hashed unique identifier from step 502. In step 506, the wireless device is awakened at the wakeup time determined in step 504

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a wireless mobile unit. In the alternative, the processor and the storage medium may reside as discrete components in a wireless mobile unit.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for waking a wireless device, said method comprising:
applying a hash function to a unique identifier;
determining a wakeup time based on the hashed unique identifier; and
waking the wireless device at the wakeup time.

2. The method of claim 1, wherein the unique identifier is an International Mobile Subscriber Identity (IMSI).

3. The method of claim 1, wherein the unique identifier is a phone number.

4. The method of claim 1, wherein the hash function produces an integer i (1≦i≦k; 1<k≦n, where k is a system parameter and n is the number of terminals in a network).

5. A wireless terminal comprising:
means for applying a hash function to a unique identifier;
means for determining a wakeup time based on the hashed unique identifier; and
means for waking the wireless device at the wakeup time.

6. The wireless terminal of claim 5, wherein the unique identifier is an International Mobile Subscriber Identity (IMSI).

7. The wireless terminal of claim 5, wherein the unique identifier is a phone number.

8. The wireless terminal of claim 1, wherein the hash function produces an integer i (1≦i≦k; 1<k≦n, where k is a system parameter and n is the number of terminals in a network).

9. Computer readable media embodying a program of instructions executable by a computer program, said computer readable media comprising:
a computer readable program code means for applying a hash function to a unique identifier;
a computer readable program code means for determining a wakeup time based on the hashed unique identifier; and
a computer readable program code means for waking the wireless device at the wakeup time.
